(19) United States
(12) Patent Application Publication
(10) Pub. No.: US 2025/0100112 A1
(43) Pub. Date: Mar. 27, 2025

(54) Transmission connecting structure for hand tools

(71) Applicant: WEI CHINS PLASTIC ENTERPRISE CORP., Taichung City (TW)

(72) Inventor: Chia-Wei Lai, Taichung City (TW)

(21) Appl. No.: 18/372,060

(22) Filed: Sep. 23, 2023

(51) Int. Cl. B25B 23/00; B25B 15/02; B25B 21/00

(52) U.S. Cl. CPC B25B 23/0035; B25B 15/02; B25B 21/00; B25B 23/0042

(57) ABSTRACT

A transmission connecting structure for hand tools has a tool bit rod. The tool bit rod has a polygonal rod member comprising an operating end at a front end and an insertion end at a rear end, the rod member further comprising a fastening section adjacent to the insertion end and a covering member between the operating end and the fastening section; the covering member further comprising a polygonal main body with an engaging groove at a front section and an enlarged stopping portion at a front end.

### BACKGROUND OF INVENTION

### Field of Invention

The present invention relates to a transmission connecting structure for hand tools, and more particularly to a transmission connecting structure for hand tools capable of being connected to different driving tools.

### Description of Related Art

Currently, a conventional tool joint structure 40, as shown in FIGS. 9 and 10, includes a handle 41, a fixed base 42 and a control member 43. The fixed base 42 is assembled at one end of the handle 41, and the fixed base 42 is used for securing a tool rod 44. The fixed base 42 is equipped with a receiving member 421 for accepting the control member 43 and at least one abutting member 422. The control member 43 is provided with at least one enclosing member 431, and the enclosing member 431 is partially in contact with the abutting member 422. One end of the enclosing member 431 extends into the fixed base 42 and secures the tool rod 44 so that when the control member 43 is applied with a force, the end of the enclosing member 431 contacting the resisting portion 422 is used as a fulcrum to lift the other end to be separated from the tool rod 44, thereby providing a convenient way to replace the tool rod 44.

However, the conventional structure as mentioned above still has the following problems in practical application: the tool rod 44 can only be assembled with the handle 41, but cannot be directly secured on the chuck of electric and pneumatic tools or be used directly. Either hand tools, electric or pneumatic require at least one specific tool bar 44.

Therefore, it is desirable to provide a transmission connecting structure for hand tools to mitigate and/or obviate the aforementioned problems.

### SUMMARY OF THE INVENTION

An objective of the present invention is to provide a transmission connecting structure for hand tools.

In order to achieve the above mentioned objective, a transmission connecting structure for hand tools has a tool bit rod. The tool bit rod has a polygonal rod member comprising an operating end at a front end and an insertion end at a rear end, the rod member further comprising a fastening section adjacent to the insertion end and a covering member between the operating end and the fastening section; the covering member further comprising a polygonal main body with an engaging groove at a front section and an enlarged stopping portion at a front end.

Other objects, advantages, and novel features of invention will become more apparent from the following detailed description when taken in conjunction with the accompanying drawings.

### BRIEF DESCRIPTION OF DRAWINGS

FIG. 1 is the perspective view of a preferred embodiment of the present invention.

FIG. 2 is an exploded view of the preferred embodiment of the present invention.

FIG. 3 shows the present invention can be applied to a variety of driving tools.

FIG. 4 shows the present invention being connected to an electric tool.

FIG. 5 shows the present invention being connected to a handle.

FIG. 6 shows the present invention when it is coupled with the rotating sleeve.

FIG. 7 shows the rotation state after the present invention being coupled with the rotating sleeve.

FIG. 8 is a schematic drawing of another preferred embodiment of the present invention.

FIG. 9 is an exploded view of a prior art structure.

FIG. 10 is a cross-sectional drawing of the prior art structure.

### DESCRIPTION OF THE PREFERRED EMBODIMENT

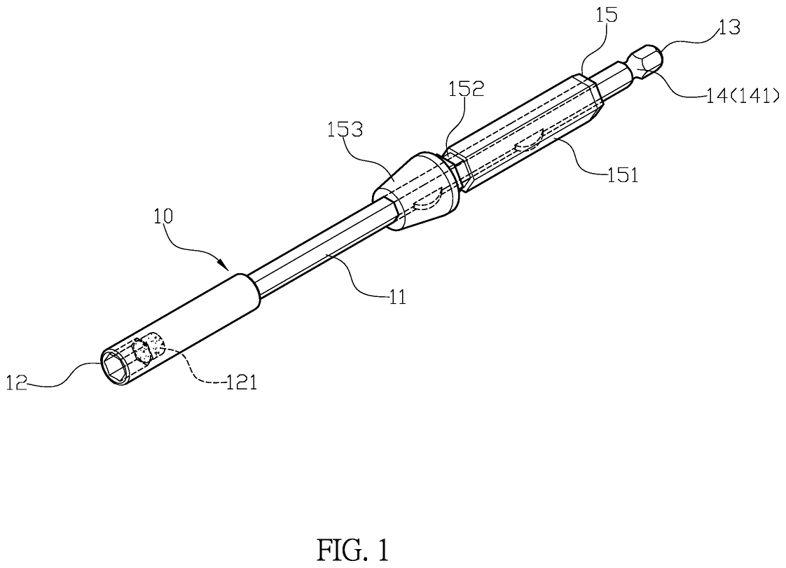

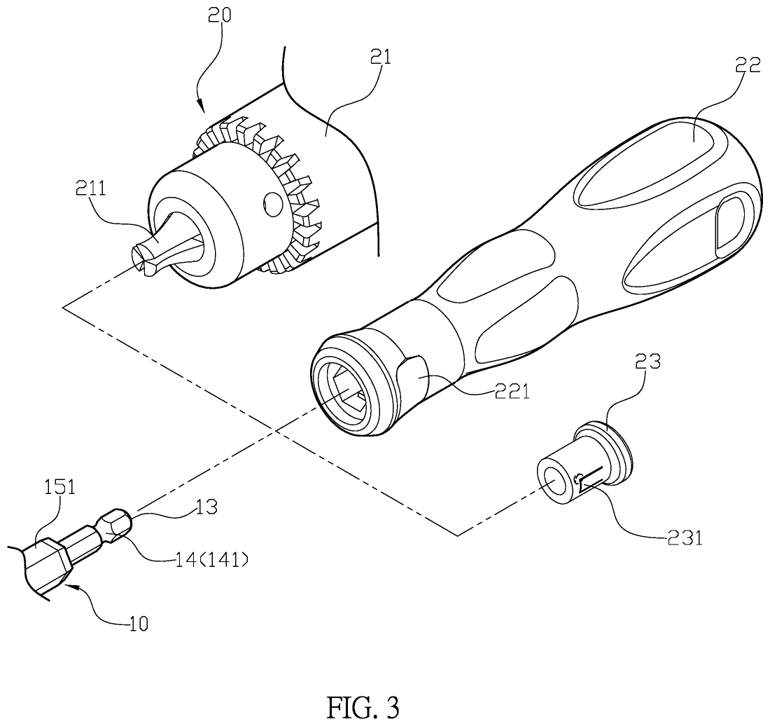

First, please refer to FIG. 1 and FIG. 3. A transmission connecting structure for hand tools comprises a tool bit rod 10. The tool bit rod 10 has a polygonal rod member 11 comprising an operating end 12 at a front end and an insertion end 13 at a rear end, and the rod member 11 further comprises a fastening section 14 adjacent to the insertion end 13 and a covering member 15 between the operating end 12 and the fastening section 14. The covering member 15 further comprises a polygonal main body 151 with an engaging groove 152 at a front section and an enlarged stopping portion 153 at a front end. With the stopping portion 153, the engaging groove 152, the main body 151, the insertion end 13 and the fastening section 14, the tool bit rod 10 can be engaged to different driving tools 20, allowing the tool bit rod 10 can be used on a variety of different driving tools 20.

Furthermore, the operating end 12 is a socket capable of securing a Screwdriver bit 30 or bolts.

Moreover, the operating end 12 is a socket, and the socket comprises an embedded magnet 121.

Also, the operating end 12 is a cross screwdriver, a slotted screwdriver, or an external hexagonal screwdriver.

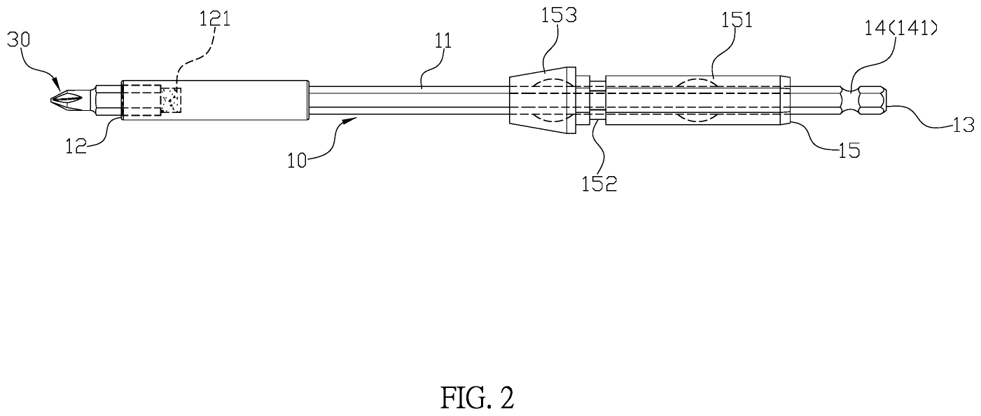

Alternatively, the fastening section 14 is a ring groove 141, please refer to to FIG. 1 to FIG. 7, the tool bit rod 10 is fastened onto the driving tool 20 via the ring groove 141.

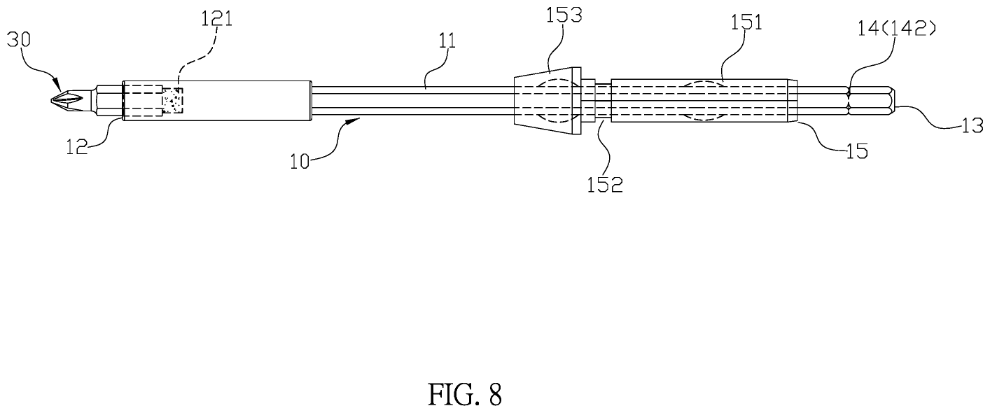

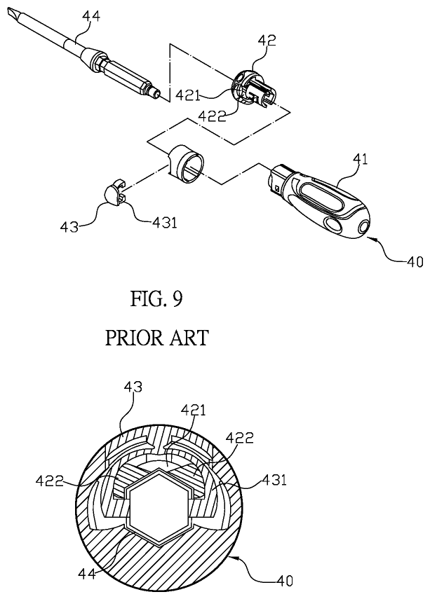

In addition, the fastening section 14 is a fastening slot 142 disposed on each corner of the rod member 11, as shown in FIG. 8, and the fastening slot 142 is capable of engaging with the elastic C hook of the driving tool 20.

Also, the rod member 11 and the main body 151 are in hexagonal shape.

Additionally, the covering member 15 is made of insulating material.

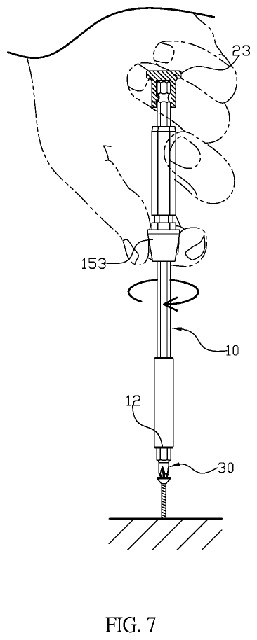

Furthermore, the stopping portion 153 is designed as a cone shape for easy gripping, as shown in FIG. 7.

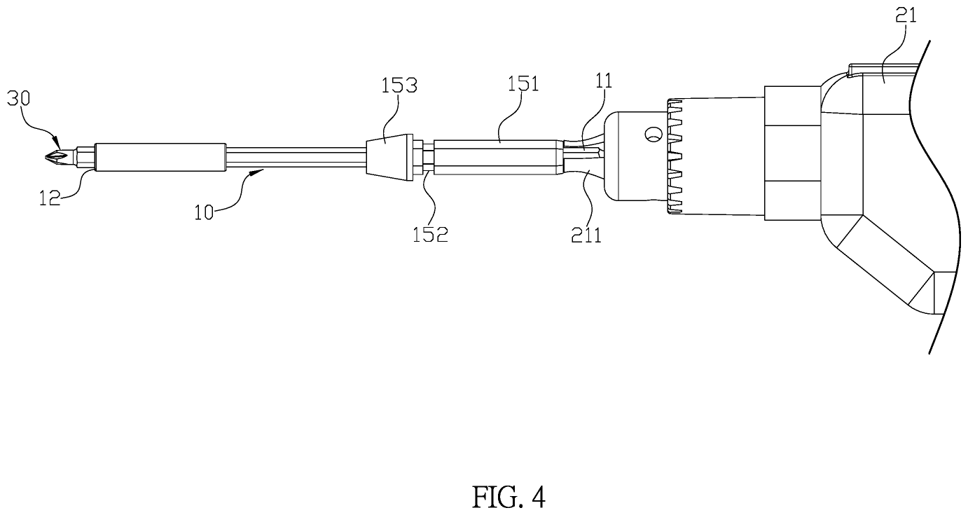

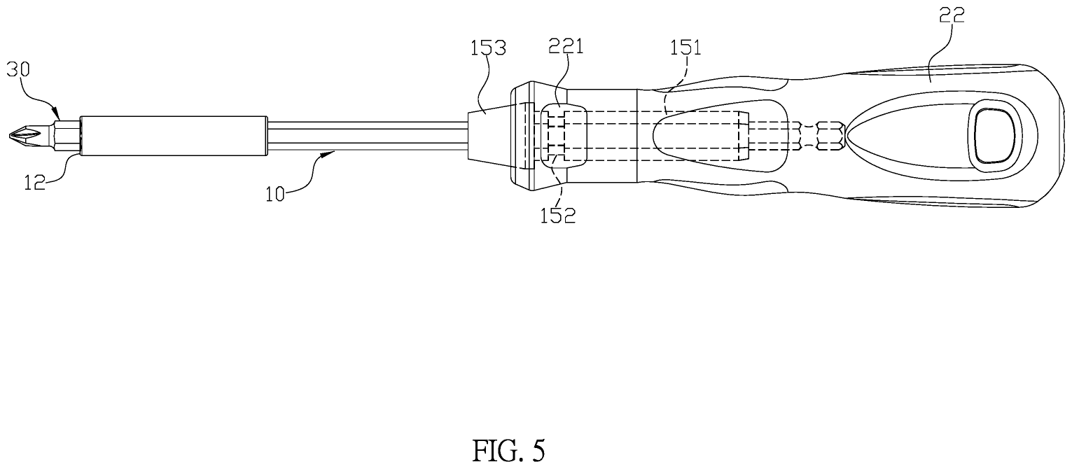

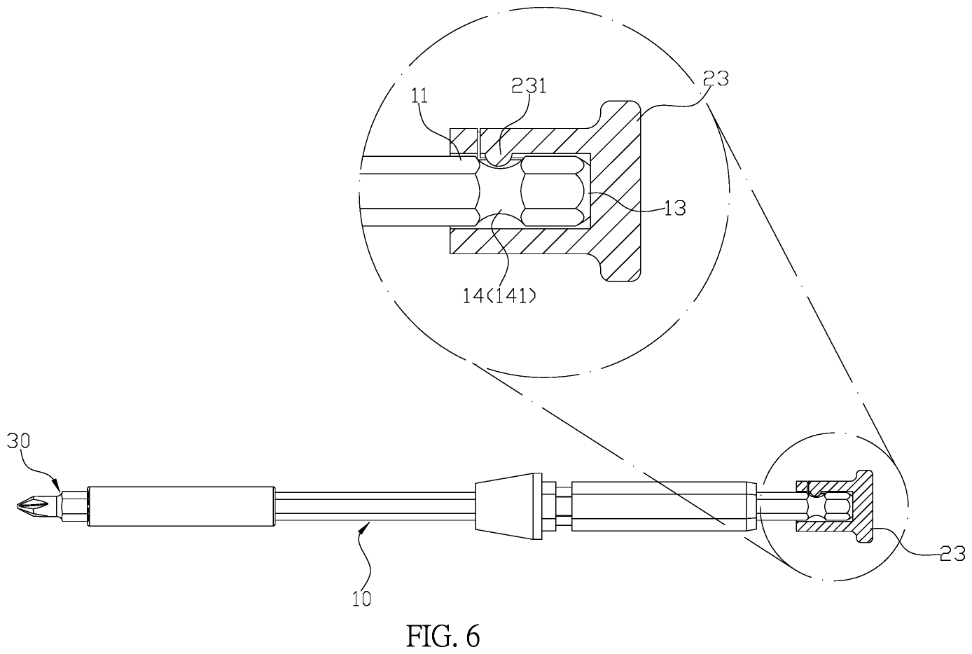

With the above structure, the driven tool 20 is an electric tool 21 or a pneumatic tool. In actual use, the insertion end 13 is inserted into the electric tool 21 or the chuck 211 of pneumatic tool clamps the rod member 11 of the tool bit rod 10, as shown in FIG. 4. When the electric tool 21 or the pneumatic tool is turned on, the electric tool 21 or the pneumatic tool can drive the tool bit rod 10 to rotate continuously. Alternatively, when the driving tool 20 is a grip handle 22, the tool bit rod 10 can be inserted into the grip handle 22 with the main body 151 and fastened with the grip handle 22 with the engaging groove 152, so that the tool bit rod 10 can also be attached on the grip handle 22, as shown in FIG. 5. By pressing the control member 221 on the grip handle 22 to release the engaging groove 152. The driving tool 20 can also be a rotating sleeve 23, and the rotating sleeve 23 is used to engage with the rod member 11, and a spring buckle 231 of the grip handle 22 engages with the ring groove 141, as shown in FIG. 6. Therefore, the tool bit rod 10 does not need to be equipped with an electric tool 21, a pneumatic tool or a grip handle 22 but can still be used as a hand tool independently, as shown in FIG. 7.

The above transmission connecting structure for hand tools has the following advantages: the tool bit rod 10 can be attached onto a variety of driven tools 20, so that the tool bit rod 10 can be applied to a variety of driven tools 20 without the need for preparing at least one dedicated tool bit rod for each different driving tool 20 which provides lower cost and less storage space storage.

Although the present invention has been explained in relation to its preferred embodiment, it is to be understood that many other possible modifications and variations can be made without departing from the spirit and scope of invention as hereinafter claimed.

What is claimed is:

1. A transmission connecting structure for hand tools comprising: a tool bit rod, wherein
the tool bit rod has a polygonal rod member comprising an operating end at a front end and an insertion end at a rear end, the rod member further comprising a fastening section adjacent to the insertion end and a covering member between the operating end and the fastening section; the covering member further comprising a polygonal main body with an engaging groove at a front section and an enlarged stopping portion at a front end.

2. The transmission connecting structure for hand tools as claimed in claim 1 wherein the operating end is a socket.

3. The transmission connecting structure for hand tools as claimed in claim 1 wherein the operating end is a socket, and the socket comprises an embedded magnet.

4. The transmission connecting structure for hand tools as claimed in claim 1 wherein the operating end is a cross screwdriver, a slotted screwdriver, or an external hexagonal screwdriver.

5. The transmission connecting structure for hand tools as claimed in claim 1 wherein the fastening section is a ring groove.

6. The transmission connecting structure for hand tools as claimed in claim 1 wherein the fastening section is a fastening slot disposed on each corner of the rod member.

7. The transmission connecting structure for hand tools as claimed in claim 1 wherein the rod member and the main body both are in hexagonal shape.

8. The transmission connecting structure for hand tools as claimed in claim 1 wherein the covering member is made of insulating material.

9. The transmission connecting structure for hand tools as claimed in claim 1 wherein the stopping portion is designed as a cone shape for easy gripping.
